(19) United States
(12) Patent Application Publication
(10) Pub. No.: US 2016/0260074 A1
(43) Pub. Date: Sep. 8, 2016

(54) SALES DATA PROCESSING APPARATUS

(71) Applicant: TOSHIBA TEC KABUSHIKI KAISHA, Tokyo (JP)

(72) Inventors: Takeshi HARAGUCHI, Izunokuni Shizuoka (JP); Toshiyasu TERAHARA, Mishima Shizuoka (JP); Takahiro SHIMURA, Gotemba Shizuoka (JP); Yuki KAWAGUCHI, Tagata Shizuoka (JP)

(21) Appl. No.: 15/011,875

(22) Filed: Feb. 1, 2016

(30) Foreign Application Priority Data
Mar. 2, 2015 (JP) 2015-040506

(51) Int. Cl. G06Q 20/20

(52) U.S. Cl. CPC G06Q 20/204; G06Q 20/20; G06Q 20/209

(57) ABSTRACT

According to the embodiment, the sales data processing apparatus includes an input interface, a bagging stand, a settlement unit, and a display. The bagging stand is disposed below the input interface. The settlement unit is a body separate from the bagging stand, and is disposed at a side of the bagging stand. The display is detachably disposed on the upper portion of the input interface, and is detachably disposed in the settlement unit.

### CROSS-REFERENCE TO RELATED APPLICATION

This application is based upon and claims the benefit of priority from the prior Japanese Patent Application No. 2015-040506, filed on Mar. 2, 2015, the entire contents of which are incorporated herein by reference.

### FIELD

The embodiments described herein generally relate to a sales data processing apparatus.

### BACKGROUND

Conventionally, in a mass merchandiser and the like, a sales data processing apparatus integrating a goods information input device, a display device, a settlement device, a bagging stand, and the like is used.

The sales data processing apparatus is also referred to as “self-checkout apparatus” or “self-POS apparatus” because the sales data processing apparatus is used by a customer so that the customer himself performs the checkout.

The mainstream layout of each of the devices such as the goods information input device in the self-checkout apparatus is as follows.

That is, the main apparatus where the goods information input device such as a scanner, the display device, and the settlement device are integrated is disposed in the center, the stand on which the shopping basket containing the goods before the checkout is to be placed is disposed on one side of the main apparatus, and the stand on which the bag for packing the goods after the checkout is to be placed is disposed on the opposite side.

In the case of the self-checkout apparatus where each of the devices is disposed as described above, the devices required for the checkout are integrated, and therefore it is difficult for the self-checkout apparatus to be used for applications other than the checkout. Therefore, the conventional self-checkout apparatus is used only as the dedicated machine for the checkout.

### BRIEF DESCRIPTION OF THE DRAWINGS

FIG. 1 is a perspective view showing the external appearance of the self-checkout apparatus according to an embodiment;

FIG. 2 is a schematic front view showing the external appearance of the self-checkout apparatus according to an embodiment;

FIG. 3 is a block diagram showing the configuration of the self-checkout apparatus according to an embodiment;

FIG. 4 is a schematic front view showing the external appearance of the accounting machine according to an embodiment; and

FIG. 5 is a block diagram showing the configuration of the accounting machine according to an embodiment.

### DETAILED DESCRIPTION

According to one embodiment, the sales data processing apparatus includes an input interface, a bagging stand, a settlement unit, and a display.

The input interface accepts the input of the goods information.

The bagging stand is disposed below the input interface. The bagging stand is a stand on which the bag for packing the goods after the acceptance of the information by the input interface is placed.

The settlement unit is a body separate from the bagging stand, and is disposed at a side of the bagging stand. The settlement unit performs accounting treatment based on the information accepted by the input interface.

The display is detachably disposed on the upper portion of the input interface, and is detachably disposed in the settlement unit. The display displays the information to be reported to the operator.

In the sales data processing apparatus according to the present embodiment, the components such as the input interface are disposed as described above. Therefore, it is possible to use the settlement unit included in the sales data processing apparatus alone as the accounting machine described below.

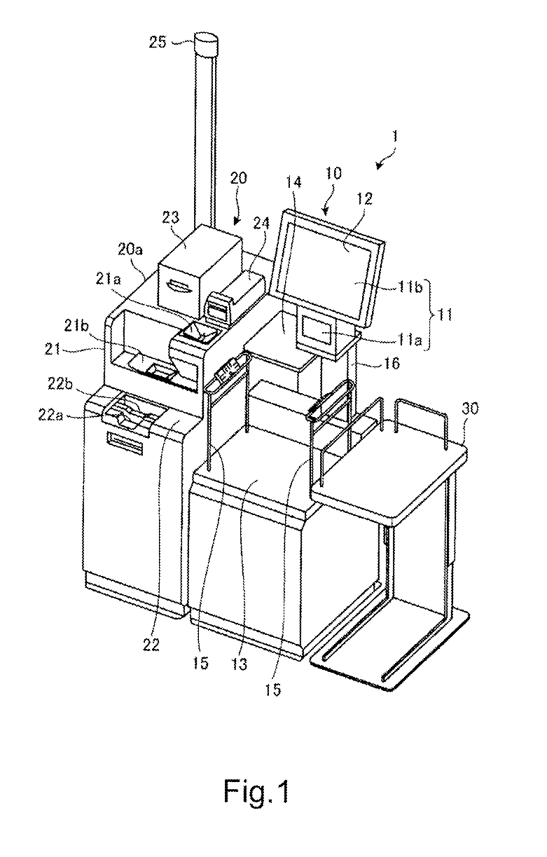

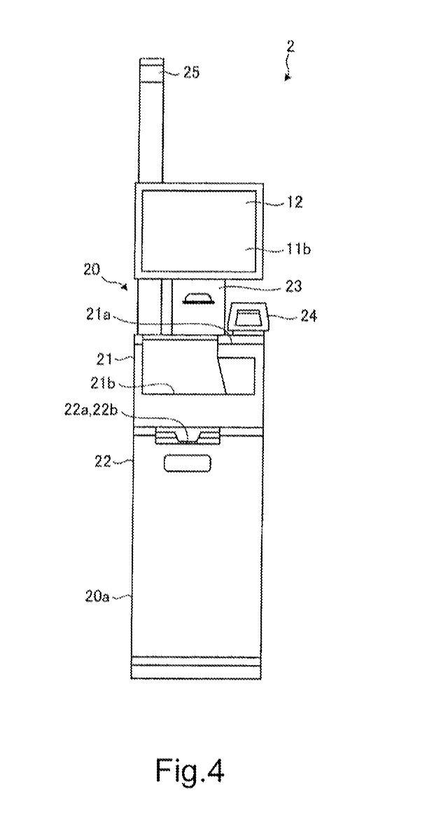

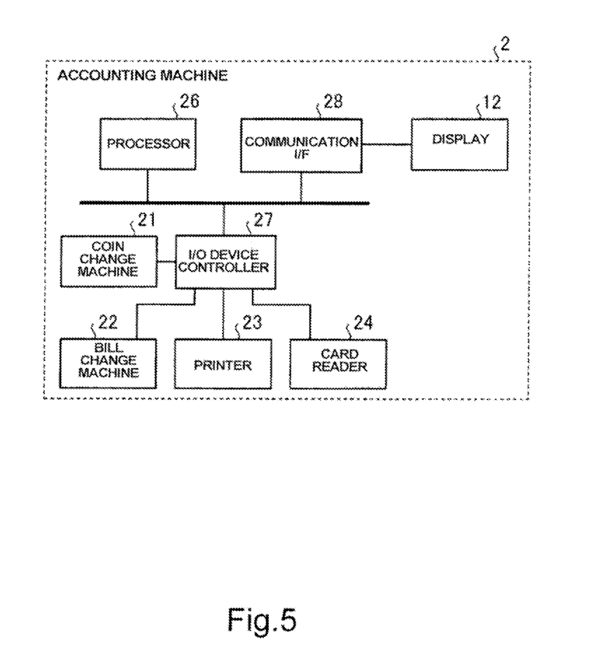

In the following, the self-checkout apparatus 1 being the sales data processing apparatus (FIGS. 1 to 3) and the accounting machine 2 (FIGS. 4 and 5) according to the embodiment will be described with reference to the drawings. In the drawings, the same reference numerals indicate the same or similar portions.

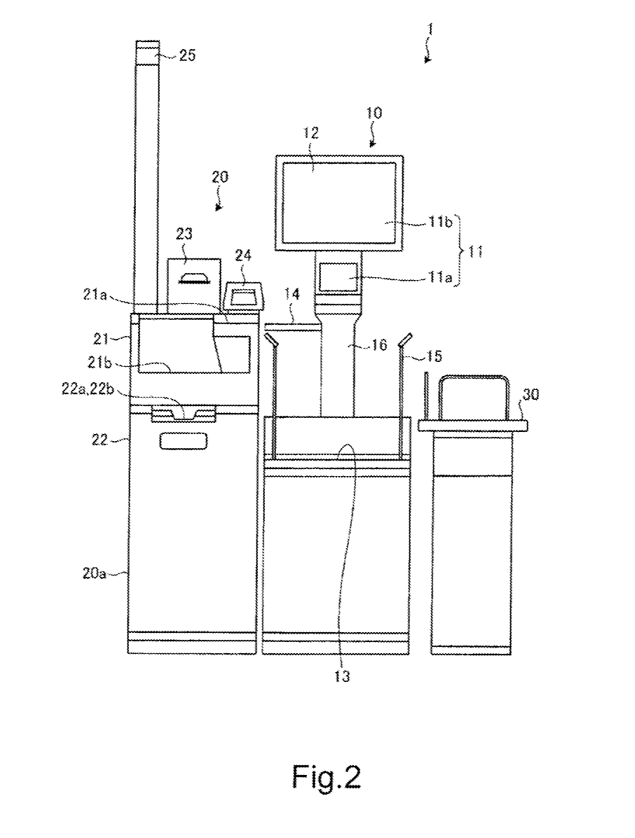

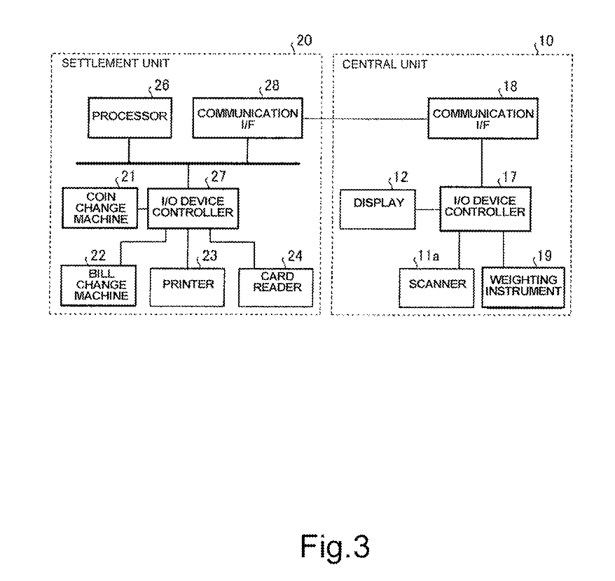

FIG. 1 is a perspective view showing the external appearance of the self-checkout apparatus 1. FIG. 2 is a schematic front view showing the external appearance of the self-checkout apparatus 1. FIG. 3 is a block diagram showing the configuration of the self-checkout apparatus 1. FIG. 4 is a schematic front view showing the external appearance of the accounting machine 2. FIG. 5 is a block diagram showing the configuration of the accounting machine 2.

The self-checkout apparatus 1 is an apparatus for a customer himself to perform the registration of the purchased goods (hereinafter, simply referred to as “goods registration”) and the settlement of the purchased goods.

The accounting machine 2 is an apparatus for a customer himself to perform the settlement.

The accounting machine 2 is, for example, installed in a semiself checkout lane in a store.

The accounting machine 2 is used by a customer after the goods registration by a clerk.

The accounting machine 2 is the settlement unit 20 which is removed from the central unit 10 of the self-checkout apparatus 1 and to which the display 12 of the self-checkout apparatus 1 is attached.

The self-checkout apparatus 1 includes a central unit 10, a settlement unit 20, and a basket placing stand 30.

The basket placing stand 30 is a placing stand on which the purchased goods are placed by the customer before the acceptance of the purchased goods information. In other words, the basket placing stand 30 is a stand for placing the shopping basket where the goods before the goods registration are put. The basket placing stand 30 is disposed at a side (on the right side when viewed from the front in the figure) of the central unit 10.

The central unit 10 is a unit for registering and bagging the purchased goods contained in the shopping basket placed on the basket placing stand 30.

The central unit 10 includes an input interface 11, a display 12, a bagging stand 13, a temporary placing stand 14, and the like.

The input interface 11 accepts the input of the purchased goods information.

The goods are things to be sold valuably (things for sale), and include tangible articles, intangible events (services), and the like.

The input interface 11 includes, for example, a scanner 11a and a touch panel 11b.

The scanner 11a reads the goods code by scanning the image obtained by the goods code being encoded. Specifically, the scanner 11a is a reading device to scan the image of the codes such as the bar code and the two-dimensional code.

The image of the code is, for example, expressed on the goods, the label attached to the goods, or the list.

The touch panel 11b is an operation unit configured to accept the manual entry by the operator (operator and customer).

The touch panel 11b is provided by overlapping on the surface of the display device 12. The touch panel 11b accepts the operation in accordance with the image displayed by the display 12.

For example, while the display 12 displays the things for sale, the touch panel 11b accepts the manual entry by the operator to select the things.

It should be noted that the input interface 11 may include a camera, a keyboard, a button, and the like. The camera is an imaging device configured to output an image obtained by imaging the goods. The keyboard and the button are an operation unit configured to accept the manual entry by the operator.

The display 12 includes, for example, a liquid crystal display panel and the like. The display 12 is disposed above or on the upper portion of the scanner 11a of the input interface 11. The display 12 displays the information to be reported to the operator.

The bagging stand 13 is disposed below the input interface 11. The bagging stand 13 is a stand on which the bag for packing the goods (articles) after the acceptance of the information by the input interface 11 is placed. In other words, the bagging stand 13 is a stand for expanding and placing the shopping bag and a stand for putting the goods thereon after the goods registration, that is, for bagging.

The basket placing stand 30 described above is disposed on a side of the bagging stand 13.

The height of the basket placing stand 30 and the height of the bagging stand 13 are almost the same.

The bag supporting members 15 are provided upright on both sides of the bagging stand 13. The operator can keep the bag open above the bagging stand 13 by hooking the handle and the like of the bag over the upper end of the bag supporting member 15.

Here, the support 16 is provided upright on the back side of the bagging stand 13.

The scanner 11a is attached to the upper end of the support 16.

In addition, the display 12 is detachably attached to the upper end of the support 16.

The space between the scanner 11a and display 12 and the bagging stand 13 is opened widely by the support 16. That is, the space for the bagging operation is formed.

The temporary placing stand 14 is attached to the support 16 and disposed above the bagging stand 13. The temporary placing stand 14 is, for example, provided so that the goods desired to be kept aside temporarily during the bagging among the goods after the goods registration are to be put thereon. The goods desired to be kept aside temporarily means, for example, the goods desirable to be bagged at the top (that is, to be bagged lastly) such as bread and eggs, and the like.

The settlement unit 20 is an example of the settlement section of the self-checkout apparatus 1. The settlement unit 20 is disposed at the side of the bagging stand 13 and on the opposite side of the basket placing stand 30 (on the left side of the bagging stand 13 when viewed from the front in the figure). That is, the settlement unit 20 is disposed at the side of the central unit 10, on the opposite side of the basket placing stand 30.

The settlement unit 20 performs accounting treatment based on the information accepted by the input interface 11. The accounting treatment is the processing including money transfer or information transfer being an alternative to the money transfer.

The settlement unit 20 is a body separate from the bagging stand 13. In other words, the settlement unit 20 is a body separate from the central unit 10.

For example, the settlement unit 20 is detachably attached to the central unit 10.

The settlement unit 20 functions as the accounting machine 2 described below by being detached from the central unit 10.

The settlement unit 20 includes a coin change machine 21 and a bill change machine 22.

On the upper surface of the housing 20a of the settlement unit 20, a printer (printing unit) 23 and a card reader (reading device) 24 are disposed.

Furthermore, the settlement unit 20 includes a warning lamp 25.

Furthermore, the display 12 is detachably attached to the settlement unit 20 as described below.

The coin change machine 21 includes a coin slot 21a and a coin outlet 21b.

The bill change machine 22 includes a bill slot 22a and a bill outlet 22b.

The coin slot 21a, the coin outlet 21b, the bill slot 22a, and the bill outlet 22b are disposed in the housing 20a.

The coin slot 21a is a deposit port that accepts insertion of coins.

The coin outlet 21b is a dispensing port through which coins are discharged.

The bill slot 22a is a deposit port that accepts insertion of bills.

The bill outlet 22b is a dispensing port through which bills are discharged.

The coin outlet 21b has the shape of a tray that receives the paid out coins.

In the depositing and dispensing of money (coins and bills), the money handling that takes most time is the takeout of coins paid out to the coin outlet 21b.

For this reason, the coin outlet 21b is disposed at the height where coins can be taken out easily.

The height is set in consideration of the height of the person assumed as the operator.

The coin slot 21a, the bill slot 22a, and the bill outlet 22b being other deposit and dispensing ports are disposed at the height as close to the coin outlet 21b as possible by setting the coin outlet 21b as the height reference.

The coin slot 21a has a funnel shape in view of easiness of throwing coins.

In addition, the coin slot 21a is disposed at a position higher than the coin outlet 21b.

Both the bill slot 22a and the bill outlet 22b have upward openings. The bill slot 22a and the bill outlet 22b are disposed in a lower position than the coin outlet 21b.

The printer 23 prints receipts, coupons, and the like to issue.

The card reader 24 reads the information stored by a credit card used for the settlement.

When it comes to a situation that the self-checkout apparatus 1 requires a recovery operation by a clerk of the store, the warning lamp 25 informs an operator around the self-checkout apparatus 1 of the occurrence of the situation by blinking light and the like.

It should be noted that the self-checkout apparatus 1 may include a reading device configured to read the data held by the recording medium not only for the credit settlement, but for other electronic settlement, for example, a reader/writer for the electronic money settlement.

As shown in the block diagram of FIG. 3, the settlement unit 20 further includes a processor 26, an input and output (I/O) device controller 27, and a communication interface (I/F) 28. The central unit 10 further includes an I/O device controller 17, a communication I/F 18, and a weighing instrument 19.

The weighing instrument 19 weighs the weight of the article placed on the bagging stand 13.

The communication I/F 18 and 28 communicatably connects the central unit 10 and the settlement unit 20 to external devices.

The I/O device controller 27 connects the coin change machine 21, the bill change machine 22, the printer 23, and the card reader 24 to the processor 26.

The I/O device controller 17 connects the display 12, the scanner 11a, and the weighing instrument 19 to the processor 26 through the communication I/Fs 18 and 28.

As shown in the block diagram of FIG. 5, the accounting machine 2 includes the settlement unit 20 and the display 12 of the self-checkout apparatus 1.

The display 12 can be connected to any of the I/O device controller 17 and the I/O device controller 27.

That is, when attached to the upper portion of the scanner 11a of the central unit 10 as shown in FIG. 1 or 2, the display 12 is connected to the I/O device controller 17 as shown in FIG. 3. In addition, when attached to the upper portion of the printer 23 of the settlement unit 20 as shown in FIG. 4, the display 12 is, for example, connected to the I/O device controller 27 through the communication I/F 28 as shown in FIG. 5. The display 12 is disposed on the upper portion of the settlement unit 20 by being attached to the upper portion of the printer 23 as described above.

The processor 26 includes a CPU (Central Processing Unit), a ROM (Read Only Memory), and a RAM (Random Access Memory).

The ROM stores various kinds of programs and various kinds of data to be executed by the CPU.

The RAM temporarily stores the data and programs when the CPU executes a program.

The processor 26 integrally controls each portion of the central unit 10 and the settlement unit 20 by expanding the program the CPU reads out from the ROM into the RAM to execute.

According to the above configuration, the self-checkout apparatus 1 can be used for the checkout the customer himself performs.

That is, the customer holds the image obtained by the goods code being encoded over the scanner 11a.

The scanner 11a outputs the goods code read by scanning the image of the code. When the goods code is output by the scanner 11a, the processor 26 refers to the PLU file stored, for example, in the self-checkout apparatus 1 or the storage device of the online-connected external device. PLU is an abbreviation for Price Look Up. The PLU file stores the name, the price, and the like of goods in association with the goods code, for example, in a tabular format.

The processor 26 obtains the information associated with the goods code read by the scanner 11a among the information stored in the PLU file. The processor 26 stores the obtained information as the information about the goods, for example, in the RAM and adds the price of the goods to the purchase amount. Thus, the processor 26 performs the goods registration.

When finishing up to goods registration and bagging of goods in the self-checkout apparatus 1, next, a customer performs the settlement. When subjected to the operation for proceeding into settlement by the customer, the self-checkout apparatus 1 displays the amount being the sum of the prices of the registered goods on the display device 12. Along with this, the settlement unit 20 starts accepting the settlement operation by the customer. The self-checkout apparatus 1 terminates one transaction with the settlement completion, and moves to a state of waiting for the start of the next transaction.

The accounting machine 2 is, as described above, the settlement unit 20 removed from the central unit of the self-checkout apparatus 1, and the settlement unit 20 where the display 12 of the self-checkout apparatus 1 is attached.

The accounting machine 2 is used for the settlement to be performed by the customer himself.

For example, the accounting machine 2 is installed in a semiself checkout lane in a store, and used for the accounting of the registered goods.

The goods registration in this case is performed by the registration machine (not shown) dedicated to goods registration such as the scanning of the image of the code indicated on the goods label.

In the semiself checkout lane, for example, first, the customer leaves the shopping basket where purchased goods are put with the clerk in charge of goods registration. The clerk registers the goods in the shopping basket in the registration machine. The information about the goods registered in the registration machine is sent from the registration machine to the accounting machine 2. When the goods registration is completed, the clerk returns the shopping basket where the goods after registration are put to the customer, and prompts the customer to perform the accounting by specifying the accounting machine 2. The specified accounting machine 2 is an accounting machine where the information about the registered goods is sent. The customer performs the operation for accounting at the specified accounting machine 2. The accounting machine 2 performs the accounting treatment based on the information about the registration goods sent from the registration machine in accordance with the customer's operation. The customer finishes the accounting at the specified accounting machine 2, whereby the transaction is completed.

According to the present embodiment, the display 12 is combined with the settlement unit 20 included in the self-checkout apparatus 1, whereby the settlement unit 20 can be made to function as the accounting machine 2. Therefore, according to the present embodiment, this enables, for example, the commonality of the production line of the self-checkout apparatus 1. Furthermore, according to the present embodiment, advantageous effects such as facilitating the inventory management and shortening the goods delivery time can be obtained.

It should be noted that although the case where the accounting machine 2 is installed in the semiself checkout lane is described in the above embodiment as an example of applications of the accounting machine 2, the embodiment is not limited to this. For example, the accounting machine 2 can also be used as a ticket-vending machine (ticketing machine) that issues meal tickets and the like for a restaurant, or as an adjustment machine in a parking lot, a station, and the like. That is, the accounting machine 2 is available in the situations that require the money transfer or the information transfer alternative to the money transfer, the printing and issuing of receipts, and the information display. The money transfer or the information transfer alternative to the money transfer includes, for example, the credit-card settlement or the electronic-money settlement. The receipt includes not only a receipt, but also a meal ticket, a voucher, a ticket, a settlement certificate, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales data processing apparatus comprising:
an input interface configured to accept an input of information about goods;
a bagging stand disposed below the input interface, the bagging stand for placing a bag for packing goods after acceptance of information by the input interface;
a settlement unit being a body separate from the bagging stand, the settlement unit positioned at a side of the bagging stand, the settlement unit configured to perform accounting treatment based on information accepted by the input interface; and
a display detachably disposed on an upper portion of the input interface and detachably disposed in the settlement unit, the display configured to display information to be notified to an operator.

2. The sales data processing apparatus according to claim 1,
wherein the settlement unit comprises a printer configured to issue a receipt.

3. The sales data processing apparatus according to claim 2,
wherein the display removed from the settlement unit is attached to an upper portion of the printer.

4. The sales data processing apparatus according to claim 1,
wherein the settlement unit comprises a coin slot that accepts insertion of coins, and a coin outlet through which coins are discharged, and
wherein the coin slot and the coin outlet are disposed at a height between the input interface and the bagging stand.

5. The sales data processing apparatus according to claim 4,
wherein the settlement unit comprises a bill slot that accepts insertion of bills, and a bill outlet through which bills are discharged, and
wherein the bill slot and the bill outlet are disposed below the coin outlet.

6. The sales data processing apparatus according to claim 1,
wherein the settlement unit comprises a card reader configured to read data held by a recording medium for electronic settlement, and
wherein the card reader is disposed on an upper portion of the settlement unit.

7. The sales data processing apparatus according to claim 1,
wherein the sales data processing apparatus comprises a central unit including the input interface, the bagging stand, and the display, and
wherein the settlement unit is detachably disposed at a side of the central unit.

8. The sales data processing apparatus according to claim 7,
wherein the display removed from the central unit is attached to the settlement unit removed from the central unit.

9. The sales data processing apparatus according to claim 8,
wherein the settlement unit removed from the central unit functions as an accounting machine.

10. The sales data processing apparatus according to claim 7,
wherein the sales data processing apparatus comprises a basket placing stand on which a shopping basket where goods before acceptance of information by the input interface are put is placed,
wherein the basket placing stand is disposed at a side of the central unit, and
wherein the settlement unit is disposed at a side of the central unit, on an opposite side of the basket placing stand.
